(19) United States
(12) Patent Application Publication
(10) Pub. No.: US 2026/0344588 A1
(43) Pub. Date: Nov. 5, 2026

(54) MULTI-FUNCTIONAL TRACTOR ATTACHMENT

(71) Applicant: Brandon Lee Courts, Kountze, TX (US)

(72) Inventor: Brandon Lee Courts, Kountze, TX (US)

(21) Appl. No.: 19/657,106

(22) Filed: Apr. 24, 2026

Related U.S. Application Data
(60) Provisional application No. 63/793,925, filed on Apr. 24, 2025.

(51) Int. Cl. A01G 23/091

(52) U.S. Cl. CPC A01G 23/091

(57) ABSTRACT

An apparatus for manipulating, extracting, and selectively cutting objects is configured for mounting to a tractor. The apparatus includes a support structure, a cutting assembly having a rotary cutting member, and a movable carriage carrying a gripping mechanism. The carriage is extendable and retractable relative to the support structure by one or more hydraulic actuators. In an extended position, the gripping mechanism is positioned outside a cutting region defined by the cutting assembly, enabling engagement and manipulation of an object independently of cutting. The carriage is retractable to move the object into the cutting region for selective cutting. The apparatus is operable to perform multiple functions, including grasping, repositioning, extracting, and cutting objects such as trees and posts.

### CROSS REFERENCE TO RELATED APPLICATION

This application claims the benefit of U.S. Provisional Application No. [63/793,925], filed on [Apr. 24, 2025], the entirety of which is hereby incorporated by reference.

### FIELD OF THE INVENTION

The present invention relates to a multi-functional tractor attachment, specifically designed for cutting, gripping, and transporting materials. More particularly, the invention provides an attachment incorporating a saw blade, a hydraulically actuated claw, and a hydraulically powered trolley, which together facilitate efficient material processing, such as forestry, agricultural, and industrial applications.

### BACKGROUND

Apparatuses for cutting and handling trees, posts, and similar objects are known. Many such devices combine a gripping mechanism with a cutting device, such as a shear or saw, mounted to a tractor or other machine. For example, U.S. Pat. No. 4,210,183 discloses a system in which grapple arms clamp a tree while shear blades cut the tree in a fixed position within a support structure. U.S. Pat. Nos. 4,690,185 and 9,795,091 describe tree felling heads in which gripping and cutting components are integrated into a single operating region. U.S. Patent Application Publication No. 2018/0070541 A1 similarly discloses a shear-type cutting head with a gripping mechanism positioned adjacent the cutting components. In these conventional systems, the gripping and cutting functions are generally arranged in a fixed spatial relationship such that an object is gripped and cut within substantially the same region. As a result, the ability to engage, manipulate, reposition, or extract an object prior to cutting is limited. In many cases, the object must be positioned directly within the cutting region before engagement and cutting occur, thereby reducing operational flexibility and control.

### SUMMARY OF THE INVENTION

The present invention relates generally to tractor-mounted equipment and, more particularly, to a multi-functional tractor attachment apparatus configured for manipulating, extracting, and selectively cutting objects such as trees, posts, and similar elongate members. The multi-functional tractor attachment apparatus includes a support structure adapted for attachment to a tractor, a cutting assembly having a cutting member that defines a cutting region, and a movable carriage carrying a gripping mechanism. The carriage is selectively extendable and retractable relative to the support structure by one or more actuators. In an extended position, the carriage positions the gripping mechanism outside the cutting region, allowing an object to be engaged, manipulated, repositioned, or extracted independently of any cutting operation. In a retracted position, the carriage moves the engaged object into the cutting region, where the cutting assembly may be selectively operated to sever the object. This configuration enables a sequence of operation in which objects may be grasped and controlled prior to cutting, thereby improving safety, precision, and versatility. The multi-functional tractor attachment apparatus is further operable in a non-cutting mode, allowing the gripping mechanism to be used for lifting, pulling, or extracting objects without activation of the cutting assembly. In some embodiments, the carriage, gripping mechanism, and cutting assembly are independently controllable, enabling flexible operation depending on the task being performed. Accordingly, the invention provides a multi-functional tractor attachment apparatus capable of both material handling and cutting operations, while allowing selective positioning of objects relative to a cutting region. This arrangement offers advantages over systems in which gripping and cutting functions are fixed or occur in a single location.

### BRIEF DESCRIPTION OF DRAWINGS

FIG. 1 is an isometric view drawing with component numberings illustrating a multi-functional tractor attachment.

FIG. 2 Is a top view drawing illustrating a multi-functional tractor attachment.

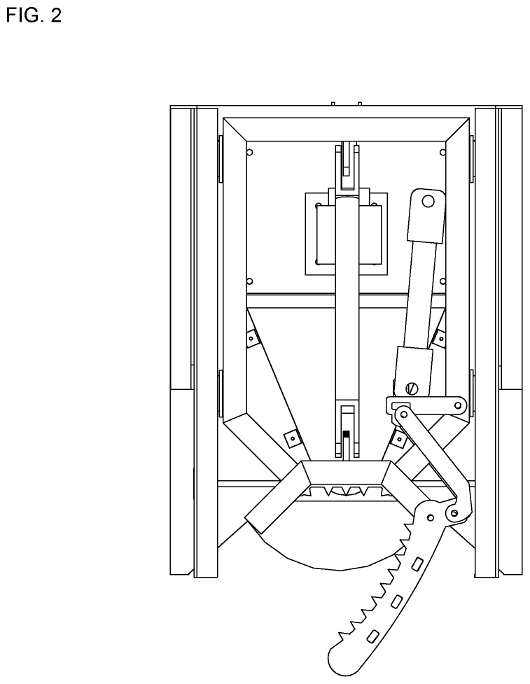

FIG. 3 Is a bottom view illustrating a multi-functional tractor attachment.

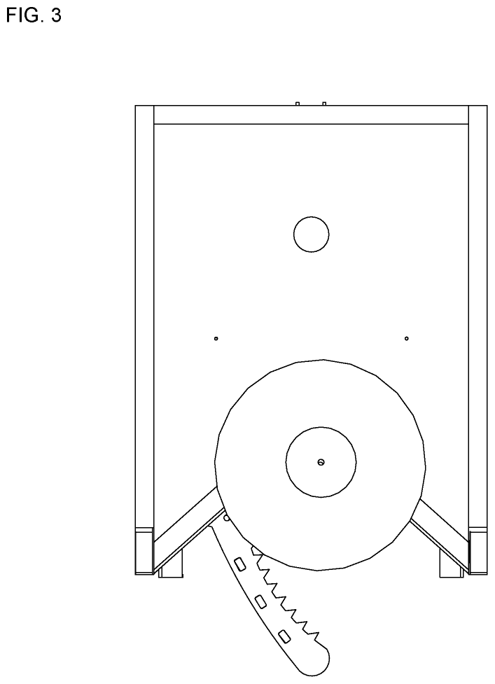

FIG. 4 Is a front view illustrating a multi-functional tractor attachment.

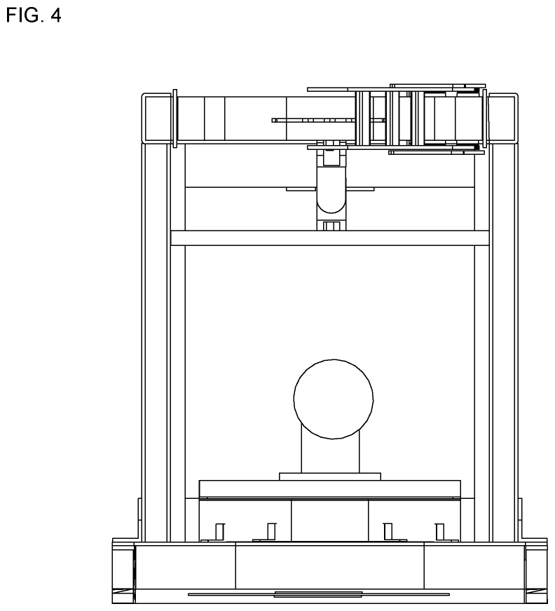

FIG. 5 Is a left view illustrating a multi-functional tractor attachment.

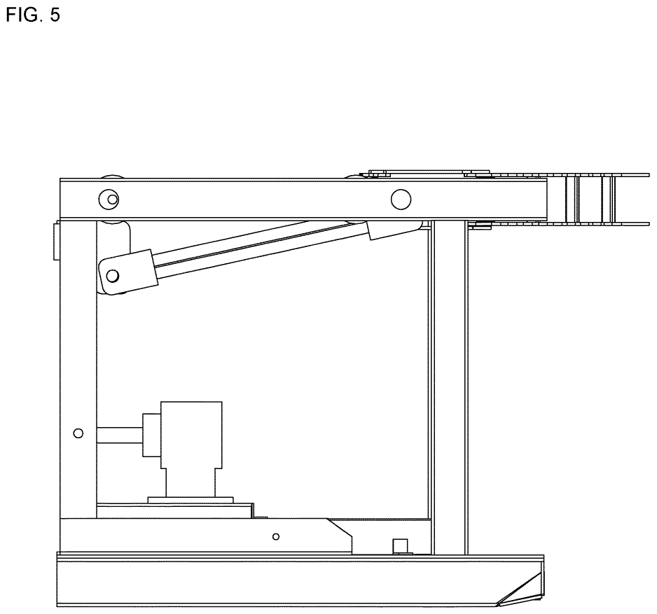

FIG. 6 Is a right view illustrating a multi-functional tractor attachment.

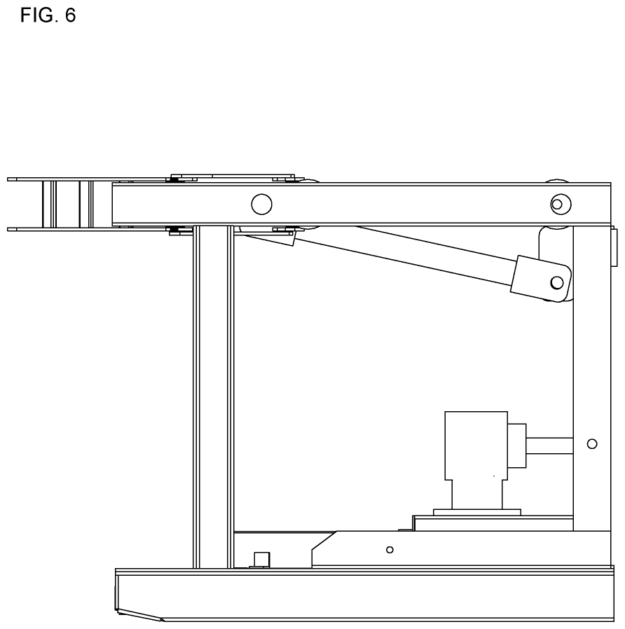

FIG. 7 Is a rear view illustrating a multi-functional tractor attachment.

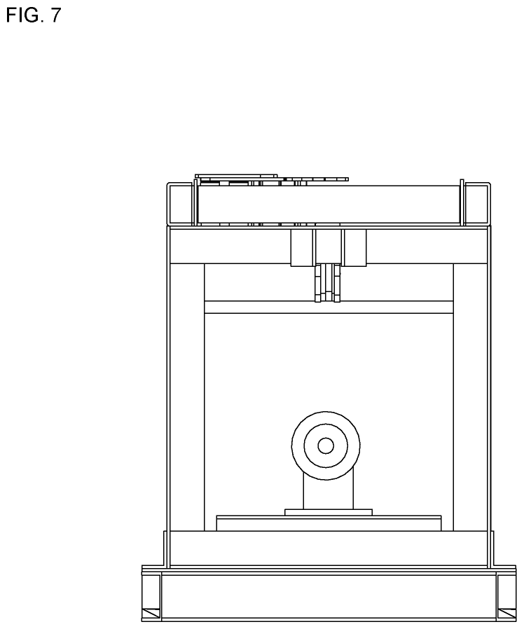

FIG. 8 Is an isometric view illustrating a multi-functional tractor attachment.

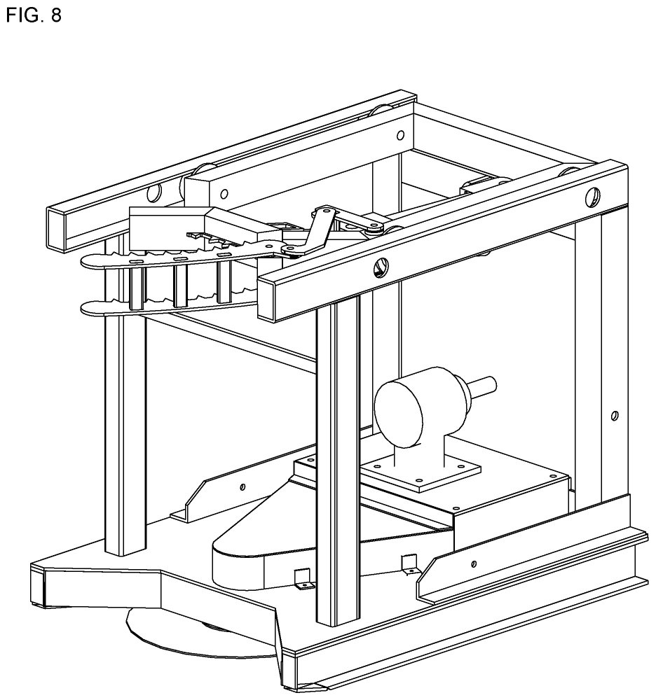

FIG. 9 is an isometric view with the belt guard 180 removed and the trolley components removed, to show the otherwise hidden components underneath that work in conjunction to transfer power from the tractor PTO gearbox 175 to the saw blade assembly.

FIG. 10 is an isometric view drawing with the trolley extended beyond the cutting radius of the blade depicting its ability to engage objects past the blade.

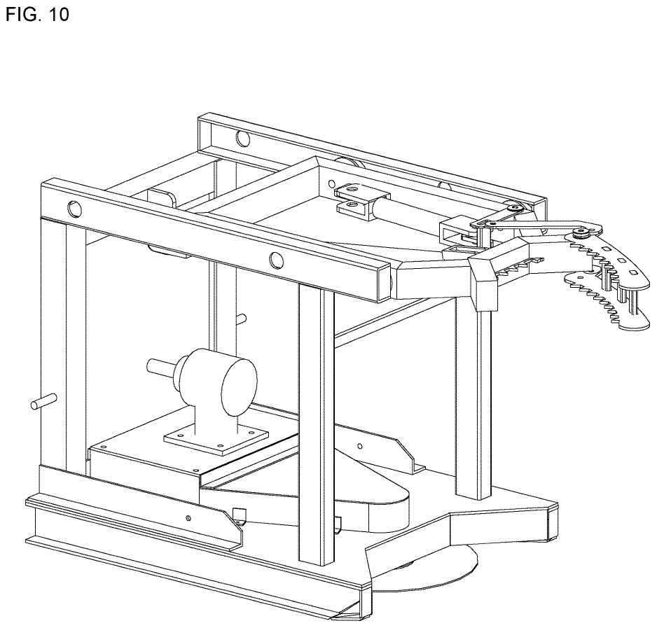

### DETAILED DESCRIPTION

### Overview

An apparatus is provided for manipulating, extracting, and selectively cutting objects such as trees, posts, and other elongate members. The apparatus is configured for mounting to a tractor for use with a three-point hitch and a power take-off (PTO) output. The apparatus generally includes a support structure, a cutting assembly, and a movable carriage that carries a gripping mechanism. The carriage is movable relative to the support structure by one or more hydraulic actuators to selectively position the gripping mechanism relative to a cutting region defined by the cutting assembly.

### Support Structure

The support structure is configured to be secured to a tractor and provides structural support for the cutting assembly and the movable carriage. In some embodiments, the support structure includes a three-point hitch interface and structural members capable of withstanding forces associated with lifting, pulling, and cutting operations. The support structure may include guide elements such as rails, tracks, or other features that direct and constrain movement of the carriage.

### Cutting Assembly

The cutting assembly is coupled to the support structure and includes a rotary cutting member, such as a circular saw blade. The cutting assembly may be driven by a power take-off of the tractor or by another suitable power source. The cutting assembly defines a cutting region corresponding to the area in which the cutting member is capable of engaging and severing an object. In some configurations, the cutting assembly is positioned near a lower portion of the support structure so that cutting occurs proximate ground level.

### Movable Carriage

A carriage is movably coupled to the support structure and is configured to translate between a retracted position and an extended position. Movement of the carriage may be guided along one or more rails, tracks, or structural members associated with the support structure. One or more hydraulic actuators, such as double-acting cylinders, are operatively connected between the support structure and the carriage. These actuators selectively drive the carriage between the retracted and extended positions. In the extended position, the carriage projects outwardly from the support structure. In the retracted position, the carriage is positioned closer to the support structure.

### Gripping Mechanism

A gripping mechanism is mounted to the carriage and is configured to engage and secure an object. The gripping mechanism may include one or more pivoting members or claws that are movable between open and closed positions. In some embodiments, the gripping mechanism is hydraulically actuated and is capable of securely grasping objects of varying sizes and shapes, including tree trunks, fence posts, and similar structures.

### Operation Outside the Cutting Region

A significant feature of the apparatus is the ability to position the gripping mechanism outside the cutting region when the trolley carriage is in the extended position. In this configuration, the gripping mechanism or claw can engage, manipulate, reposition, or extract an object without interference from the cutting assembly. This allows the apparatus to perform functions independent of cutting, including lifting, pulling, and aligning objects prior to any cutting operation. The carriage may be configured such that, in the extended position, the gripping mechanism is located beyond the maximum reach or effective range of the cutting member.

### Transition to Cutting

After an object has been engaged and optionally manipulated or extracted while the carriage is extended, the hydraulic actuators may be operated to retract the carriage toward the support structure. During retraction, the object held by the gripping mechanism is moved toward and into the cutting region. Once positioned within the cutting region, the cutting assembly may be activated to sever the object. This sequence enables controlled positioning and stabilization of the object prior to cutting.

### Independent Operation

In some configurations, the carriage, gripping mechanism, and cutting assembly are independently controllable. This enables selective operation of gripping, manipulation, extraction, and cutting functions. For example, the gripping mechanism may be used to extract a fence post from the ground without activating the cutting assembly. Similarly, objects may be lifted or repositioned without any cutting operation.

### Alternative Embodiments

Various modifications and alternative configurations may be employed without departing from the scope of the invention. For example, the carriage may move along linear, curved, or other guided paths. The gripping mechanism may include different types of engagement structures such as clamps, jaws, or other securing devices. The cutting assembly may include alternative cutting members, including rotary blades, reciprocating blades, or shearing elements. The apparatus may also be adapted for use with different types of vehicles or mounting systems.

### Functional Advantages

The apparatus provides several advantages, including the ability to position a gripping mechanism outside a cutting region, manipulate objects independently of cutting operations, and subsequently move objects into a cutting region for controlled cutting. This configuration enables improved versatility, control, and safety compared to systems in which gripping and cutting functions occur at a fixed or integrated location.

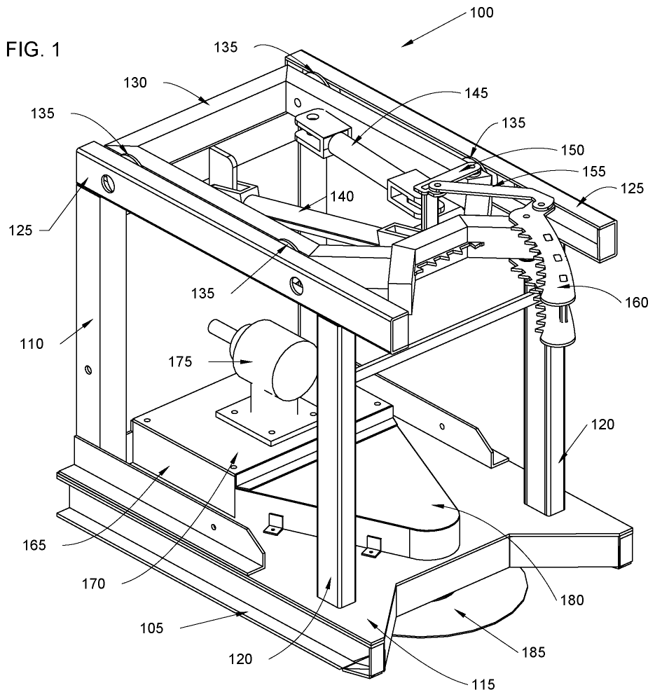

FIG. 1 is an isometric view drawing with component numberings illustrating a multi-functional tractor attachment 100, including a base frame 105, 3-point attachment frame 110, base plate 115, (2) trolley rail supports 120, (2) trolley rails 125, trolley 130, (4) trolley wheels 135, trolley actuating hydraulic cylinder 140, claw actuating hydraulic cylinder 145, claw articulating cylinder mount 150, (2) claw leverage arms 155, claw 160, (2) PTO base channels 165, PTO mount plate 170, PTO gearbox 175, belt guard 180, and saw blade 185.

The base frame 105 is constructed out of heavy gauge c-channel steel. It is the base framework of the machine. It is rigid to carry the heavy stresses that the machine may encounter.

The 3-point attachment frame 110 is the framework in which the typical tractor will attach to the multi-functional tractor attachment.

The base plate 115 is a heavy gauge steel plate that is connected to the base frame and provides rigidity. It is the main point of attachment for the 3-point attachment frame 110, (2) trolley rail supports 120, (2) PTO base channels 165, belt guard 180, belt idler pulley 195, idler pulley tension leverage arm 200, and saw blade spindle 215.

The trolley rail supports 120 are heavy gauge steel that supports the trolley rails 125.

The trolley rails 125 are heavy gauge steel channels that the trolley wheels 135 ride inside of. The trolley rails allow the trolley 130 to extend and retract in a linear motion.

The trolley 130 is heavy gauge steel tubing material that can extend and retract in a linear motion.

The trolley wheels 135 allow the trolley to roll smoothly without friction. They attach to the trolley 130 and ride inside the trolley rails 125.

The trolley actuating hydraulic cylinder 140 gives the trolley the ability to extend and retract by means of hydraulic pressure. The trolley actuating hydraulic cylinder is controlled via tractor controls and connected to the tractor hydraulic control system via hydraulic hoses.

The claw actuating hydraulic cylinder 145 gives the claw 160 the ability to open and close. The claw actuating hydraulic cylinder is controlled via tractor controls and connected to the tractor hydraulic control system via hydraulic hoses.

The claw articulating cylinder mount 150 is attached to the trolley 130 at one end and connected to the claw leverage arms 155 at the other end. The claw actuating hydraulic cylinder 145 attaches to the center of the claw articulating cylinder mount.

The claw leverage arms 155 connect to the claw articulating cylinder mount 150 at one end and to the claw 160 at the opposite end. The claw leverage arms are linkages used to open and close the claw via motion exerted from the claw articulating cylinder mount 150.

The claw 160 is a heavy gauge steel toothed structure used to grasp hold of an object. The claw can open and close.

The PTO base channels 165 are heavy gauge steel channels that support the PTO gearbox 175.

The PTO gearbox mount plate 170 is a heavy gauge steel plate that the PTO gearbox 175 directly attaches. The PTO mount plate 170 mounts on top of the PTO base channels 165.

The PTO (Power Take-Off) gearbox 175 is a mechanical device that transfers power from the tractor's PTO shaft to the driven equipment, often modifying speed, torque, or direction to match the implements requirements.

The belt guard 180 is a heavy gauge protective barrier device. It shields the user from contacting the internal moving parts during operation and protects the internal moving parts from the outdoor elements.

The saw blade 185 is a rotating circular blade with teeth, used for cutting objects such as wood and other materials.

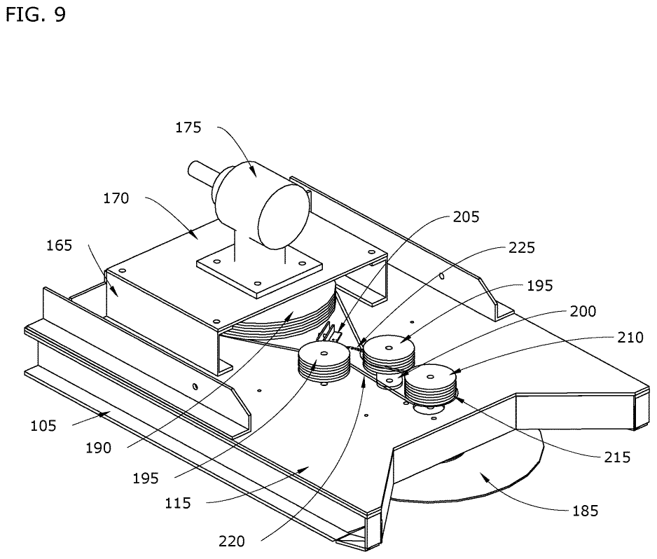

FIG. 9 This drawing uses partial cutaway or hidden details for the purpose of showing the components that work in conjunction to transfer power from the tractor PTO gearbox to the saw blade assembly. The belt guard 180 is removed in this view to show details of the components underneath it. This detail drawing shows the base frame 105, base plate 115, PTO base channels 165, PTO gearbox mount plate 170, PTO (Power Take-Off) gearbox 175, saw blade 185, large diameter grooved pulley 190, idler pulleys 195, idler pulley tension leverage arm 200, spring adjuster mount 205, Blade spindle pulley 210, blade spindle 215, belt 220, and the tension spring 225.

The large diameter grooved pulley 190 is a pulley that turns at a 1:1 speed of the gearbox output shaft. The pulley is grooved to work in conjunction with a belt(s) to transfer power to the saw blade spindle pulley 210. The large pulley working in conjunction with the small pulley increases the saw blade rotational speed proportional to ratio of the pulleys.

The idler pulleys 195 guide the belt and provide tension pressure in the belt and pulley drive system.

The idler pulley tension leverage arm 200 has an idler pulley 195 attached at one end and bolts (loosely) to the base plate 115 at the other end. The bolt end of the assembly is a pivot point. A heavy-duty tension spring is connected at the idler pulley end of the idler pulley tension arm and then connects to the spring adjuster mount 205 with the other end. The purpose of the assembly is to take up slack in the belt(s) system by pulling the idler pulley against the belt(s) via spring pressure.

The spring adjuster mount 205 is an adjustable spring mounting point.

The Blade spindle pulley 210 is a small, grooved pulley that the belt(s) engages to drive the blade spindle 215.

The blade spindle 215 is attached to the underside of the base plate 115. It is a rotating shaft assembly that holds and drives the saw blade 185.

The belt 220 is used to transfer power from the large diameter grooved pulley 190 to the blade spindle pulley 210.

The tension spring 225 exerts a pulling force between the spring adjuster mount 205 and the idler pulley tension leverage arm 200.

In conclusion, the present invention provides a multi-functional tractor attachment integrating a saw blade, trolley, and claw mechanism into a single, efficient system for cutting, transporting, and handling materials. This innovation enhances versatility, reduces operational time, and improves efficiency in agricultural, forestry, farming, ranching and industrial applications. While specific embodiments have been described, modifications and variations may be made without departing from the spirit and scope of the invention as described.

1. A multi-functional tractor attachment apparatus for manipulating and selectively cutting objects comprising: a. a chassis configured for mounting to a tractor; b. a cutting or shearing device affixed to the chassis defining a cutting zone; c. at least one hydraulic actuator operatively connected to the trolley assembly and configured to selectively extend and retract the trolley assembly relative to the mounting frame; d. a gripping assembly mounted to the trolley assembly and configured to engage an object; e. wherein the trolley assembly is configured to position the gripping assembly at a location extending beyond the cutting zone of the rotary saw blade such that the gripping assembly is operable to engage, manipulate, or extract the object prior to positioning the object within the cutting zone for cutting by the rotary saw blade.

2. The apparatus of claim 1, wherein the hydraulic actuator comprises at least one hydraulic cylinder extending between the mounting frame and the trolley assembly.

3. The apparatus of claim 1, wherein the trolley assembly is guided along a linear path relative to the mounting frame.

4. The apparatus of claim 1, wherein the gripping assembly comprises at least one pivoting claw configured to selectively open and close to engage an object.

5. The apparatus of claim 1, wherein the cutting assembly is positioned at a lower portion of the mounting frame such that the rotary saw blade is operable proximate ground level.

6. The apparatus of claim 1, wherein the trolley assembly is configured to extend the gripping assembly to a position forward of and laterally offset from the cutting zone.

7. The apparatus of claim 1, wherein the gripping assembly is operable to extract an object from the ground without activation of the cutting assembly.

8. The apparatus of claim 1, wherein the trolley assembly and the cutting assembly can are independently controllable.

9. The apparatus of claim 1, wherein retraction of the trolley assembly positions an object engaged by the gripping assembly within the cutting zone.

10. The apparatus of claim 1, wherein the gripping assembly is configured to engage elongate objects including fence post or tree trunks.

11. The apparatus of claim 1, further comprising a power take-off (PTO) driven mechanism operatively connected to the rotary saw blade.

12. The apparatus of claim 1, wherein the trolley assembly is configured to extend beyond a maximum radial reach of the rotary saw blade.

13. A method of manipulating and selectively cutting an object using a tractor mounted apparatus having a gripping assembly and a rotary cutting assembly, the method comprising: extending a trolley assembly relative to a mounting frame to position the gripping assembly at a location outside a cutting zone of the rotary cutting assembly; engaging the object with the gripping assembly; manipulating the object with the gripping assembly; manipulating the object while positioned outside the cutting zone; retracting the trolley assembly to move the object toward the cutting zone; and selectively cutting the object with the rotary cutting assembly.

14. The method of claim 13, further comprising extracting the object from the ground prior to cutting.

15. The method of claim 13, where in manipulating the object includes repositioning or aligning the object prior to cutting.

16. The method of claim 13, wherein the gripping and cutting steps are performed independently.

17. An apparatus for handling and processing objects comprising: a support structure configured for attachment to a tractor; a cutting member coupled to the support structure and defining a cutting region; a carriage movable relative to the support structure between a retracted position and an extended position; an actuator configured to drive movement of the carriage between the retracted and extended positions; a gripping mechanism carried by the carriage; wherein the extended position, the gripping mechanism is disposed outside the cutting region and is operable to engage and manipulate an object independently of the cutting member; and wherein the retracted position, the gripping mechanism is configured to position the object within the cutting region for selective cutting.

18. A material handling subassembly for a tractor-mounted apparatus, comprising: a carriage configured for guided movement relative to a support frame; at least one hydraulic actuator configured to translate the carriage between extended and retracted positions; and a gripping mechanism mounted to the carriage; wherein the carriage is configured to position the gripping mechanism at a location spaced from a cutting assembly associated with the support frame to enable manipulation of an object prior to cutting.

19. The subassembly of claim 18, wherein the carriage is guided along at least one rail or track.

20. The subassembly of claim 18, wherein the gripping mechanism comprises opposed pivoting members actuated to secure the object.

21. The subassembly of claim 18, wherein the hydraulic actuator comprises a double acting cylinder.

22. The subassembly of claim 18, wherein the carriage is configured to extend beyond the radius of the cutting assembly.

23. The subassembly of claim 18, wherein the gripping mechanism is configured to extract an embedded object from the ground.
